(19) United States
(12) Patent Application Publication
(10) Pub. No.: US 2018/0353864 A1
(43) Pub. Date: Dec. 13, 2018

(54) Live Fire Gaming System

(71) Applicant: Visual Shot Recognition Gaming, LLC, Dallas, TX (US)

(72) Inventor: David Valdez, Dallas, TX (US)

(21) Appl. No.: 16/000,544

(22) Filed: Jun. 5, 2018

Related U.S. Application Data
(60) Provisional application No. 62/516,711, filed on Jun. 8, 2017.

(51) Int. Cl. A63F 13/837; A63F 13/65; A63F 13/46; F41J 5/10; A63F 13/2145; A63F 13/335

(52) U.S. Cl. CPC A63F 13/837; A63F 13/65; A63F 13/335; F41J 5/10; A63F 13/2145; A63F 13/46

(57) ABSTRACT

The present disclosure generally relates to systems and methods for integrating image processing with shooting sports, and in particular, image processing shot recognition gaming (“Live Fire Gaming”) which utilizes image processing to track shot performance metrics for one or more players, in person or online, in a dynamic, recreational gaming context. In some implementations, the system according to the present disclosure may comprise a shooting device for shooting projectiles onto a target; a camera for capturing and collecting images of impact points of the projectiles on the target; a processing means coupled to the camera for calculating a performance metric based on data relating to the images of the impact points of the projectiles on the target; and a touch screen display coupled to the processing means for displaying the performance metric.

### CROSS-REFERENCE TO RELATED APPLICATIONS

This application claims the benefit of, and priority to, U.S. Provisional Patent Application Ser. No. 62/516,711, filed on Jun. 8, 2017 and entitled “Image Processing (IP) Shot Recognition Gaming”, the content of which is incorporated herein by reference.

### BACKGROUND

Shooting sports generally involve utilizing various shooting mediums (typically a type of firearm, bow, or the like) to propel a projectile (typically a bullet, round, arrow, or shot) at a target to measure the shooter's proficiency and performance, including accuracy and consistency. This activity typically comprises two components: a shooting device to be fired by a user and a target, such as a paper target. In prior art shooting systems, a shooter attempts to score “hits” as close as possible to a marked center of the defined target. After completing a desired number of shots, the shooter may evaluate his/her performance up-close only by leaving his/her shooting stall and conducting an inspection of the target itself. These prior art systems do not offer means to remotely evaluate and quantify performance using automated systems and/or methods, and fail to provide the shooter the dynamic and interactive ability to measure their performance against other shooters in various recreational gaming formats and/or applications. The prior art also fails to allow the shooter to clearly distinguish his/her shots, the option and ability to electronically share his/her performance metrics, or the ability to post previous shooting sessions for performance comparison.

### SUMMARY OF THE INVENTION

The present disclosure generally relates to systems and methods for integrating image processing (also referred to as “IP”) with shooting sports, and in particular image processing shot recognition gaming (“Live Fire Gaming”) which utilizes image processing to track shot performance metrics for one or more players, in person or online, in a dynamic, recreational gaming context.

In some implementations, the system according to the present disclosure may comprise a shooting device for shooting projectiles onto a target; a camera for capturing and collecting images of impact points of the projectiles on the target; a processing means coupled to the camera for calculating a performance metric based on data relating to the images of the impact points of the projectiles on the target; and a touch screen display coupled to the processing means for displaying the performance metric.

In some implementations, the method according to the present disclosure may comprise firing one or more projectiles from a shooting device onto a target; capturing images relating to one or more impact points of the projectiles on the target; calculating a performance metric based on the images relating to the one or more impact points of the projectiles on the target; and displaying the performance metric on a touch screen device.

The details of one or more implementations are set forth in the accompanying drawings and the description below. Other features, objects, and advantages of the implementations will be apparent from the description, drawings.

### BRIEF DESCRIPTION OF THE DRAWINGS

For a more complete understanding of this disclosure, its features, and additional implementations, reference is now made to the following description, taken in conjunction with the accompanying drawings, in which:

FIG. 1 illustrates a Live Fire Gaming system and methods according to a preferred embodiment of the present disclosure.

FIG. 2 illustrates a user-interface flow diagram depicting the method of the Live Fire Gaming system according to a preferred embodiment of the present disclosure.

FIG. 3 illustrates a user-interface of a “Home View” screen of the Live Fire Gaming system according to a preferred embodiment of the present disclosure.

FIG. 4 illustrates a user-interface of a “How to Play” screen of the Live Fire Gaming system according to a preferred embodiment of the present disclosure.

FIG. 5 illustrates a user-interface of a “How to Play” “Target Play” screen of the Live Fire Gaming system according to a preferred embodiment of the present disclosure.

FIG. 6 illustrates a user-interface of a “How to Play” “Cricket Play” screen of the Live Fire Gaming system according to a preferred embodiment of the present disclosure.

FIG. 7 illustrates a user-interface of a “How to Play” “Timed Play” screen of the Live Fire Gaming system according to a preferred embodiment of the present disclosure.

FIG. 8 illustrates a user-interface of a “How to Play” “Uploading Scores” screen of the Live Fire Gaming system according to a preferred embodiment of the present disclosure.

FIG. 9 illustrates a user-interface of a “Begin Play” screen of the Live Fire Gaming system according to a preferred embodiment of the present disclosure.

FIG. 9A illustrates a user-interface of a “Begin Play” “Game Scores” screen of the Live Fire Gaming system according to a preferred embodiment of the present disclosure.

FIG. 9A1 illustrates an exemplary scorecard file for emailing and/or uploading for the Live Fire Gaming system according to a preferred embodiment of the present disclosure.

FIG. 9B illustrates a user-interface of a “Begin Play” “Leaderboards” screen of the Live Fire Gaming system according to a preferred embodiment of the present disclosure.

FIG. 10 illustrates a user-interface of a “Begin Play” “Target Play” screen of the Live Fire Gaming system according to a preferred embodiment of the present disclosure.

FIG. 11 illustrates a user-interface of a “Begin Play” “Ready” screen of the Live Fire Gaming system according to a preferred embodiment of the present disclosure.

FIG. 11A illustrates a user-interface of a further “Begin Play” “Target Play” screen of the Live Fire Gaming system according to a preferred embodiment of the present disclosure.

FIG. 12 illustrates a user-interface of a “Begin Play” “Target Play Scores” screen of the Live Fire Gaming system according to a preferred embodiment of the present disclosure.

FIG. 13 illustrates a user-interface of a “Begin Play” “Cricket Play” screen of the Live Fire Gaming system according to a preferred embodiment of the present disclosure.

FIG. 13A illustrates a user-interface of a further “Begin Play” “Cricket Play” screen of the Live Fire Gaming system according to a preferred embodiment of the present disclosure.

FIG. 14 illustrates a user-interface of a “Begin Play” “Timed Play” screen of the Live Fire Gaming system according to a preferred embodiment of the present disclosure.

FIG. 14A illustrates a user-interface of a further “Begin Play” “Timed Play” screen of the Live Fire Gaming system according to a preferred embodiment of the present disclosure.

### DETAILED DESCRIPTION

Embodiments of the present disclosure generally provide systems and methods that integrate image processing with the shooting sports, and more particularly create and deliver a Live Fire Gaming system which may be used to track performance metrics such as accuracy, speed, number of attempts, and other useful measurements for individual or multiple shooters (user/s), in person or online. The Live Fire Gaming systems and methods may comprise a plurality of different features, interactions, dynamics, abilities, and components, and are not to be limited to the specific implementations described herein.

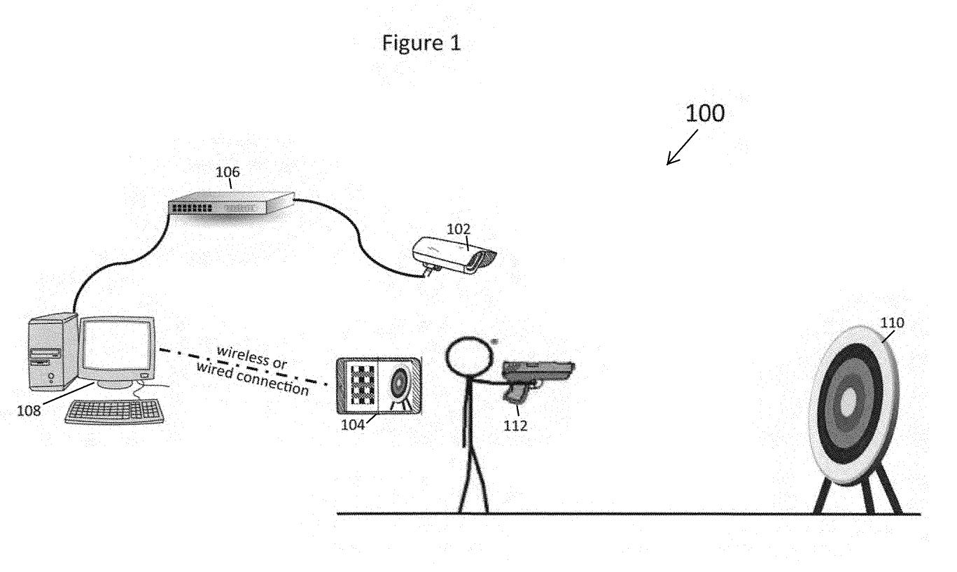

FIG. 1 depicts a Live Fire Gaming system 100 according to a preferred embodiment of the present disclosure. Live Fire Gaming system 100 generally comprises a shooting device 112 for discharging projectiles; at least one target 110 for receiving hits of discharged projectiles; at least one camera 102 to capture, collect, and relay live images at predetermined frames per second (fps) to distinguish changes in the target 110 effected by projectiles discharged from the shooting device 112; at least one computer processing server 108 that receives the live images from the camera 102, processes the live images to identify the projectile hits (or impact points) on the target 110, generates performance metrics therefrom, and administratively manages the overall Live Fire Gaming system 100; and a touch screen device 104 that receives the performance metrics generated by computer processing server 108, displays the performance metrics as well as the impact points on the target 110 on a corresponding user-interface screen, and further enables a user to interface with the Live Fire Gaming system 100 (e.g., by selecting from a menu of gaming options, inputting player information, receiving instructions, visually displaying images of the target 110 relayed from the camera 102 during game play, viewing player proficiency, displaying a player's past shooting sessions, uploading player proficiency, etc.) Communication and/or transmission of data between the camera 102 and the computer processing server 108, as well as between computer processing server 108 and touch screen device 104 may occur through network, cloud, Wi-Fi or other connection means known in the art.

In other implementations having multi-player formats, multiple cameras and multiple touch screen devices may be used. In such implementations, one or more cameras 102 may be connected to an Ethernet switch 106 that may then directly relay the individual live camera images from the one or more cameras 102 to the computer processing server 108. The computer processing server 108 may then make available the generated performance metrics to each of the corresponding touch screen devices 104.

The computer processing server 108 may comprise a central processing unit for processing information; an image processing (“IP”) algorithm for analyzing and processing images transmitted via camera 102; an analysis program for generating performance metrics based on the analysis and processing of images by the IP algorithm; a database or other storage device for storing generated performance metrics, along with acquired, calculated and other generated data; a wired or wireless connection to enable the touch screen device 104 to access and display the generated performance metrics, as well as display player information and gaming interface; a bus system for communication between components of the computer processing server; a wireless, cloud, or web interface for communication with and transmission to the world wide web or external devices; and may further comprise other elements and/or components known in the art.

The Live Fire Gaming system 100 may be used in a variety of environments and contexts, and is not limited to any particular embodiment herein disclosed. For example, shooting device 112 may comprise any type of firing device, including but not limited to a firearm, a pistol, a gun, a rifle, a “play” gun, a device capable of projecting a projectile, a signal, a laser, light, etc. Likewise, target 110 may comprise any form of target known in the art, including paper targets, steel targets, a bulls-eye, silhouettes, etc., as may be determined by the user. Point values or proficiency metrics may be assigned to various areas of the target and quantified in various manners to measure a user's proficiency and performance.

With continued reference to FIG. 1, a method of Live Fire Gaming according to the present disclosure will now be described. Using touch screen device 104, a user may review and select a desired gaming option. Selections may be based on preferred type of game, number of players desired by the user, and/or any other variable user option. After selecting a gaming option and reviewing any instructions, the user may, with the shooting device 112, assume a position at a designated distance from target 110. The touch screen device 104 may provide the user with gaming information as well as an enlarged live view of the target 110. As the user fires one or more projectiles from shooting device 112, camera 102 captures and collects images at pre-determined frames per second and relays images of the target 110 with the impact point(s) of the projectile(s) to the computer processing server 108. The computer processing server 108 transmits the captured images of the target 110 with impact points thereon to the touch screen device 104. Touch screen device 104 displays an image of target 110 along with each impact point of the projectile upon the target 110. Each impact point may be displayed on touch screen device 104 by a colored marker. The touch screen device 104 may refresh the image of the target 110 with a new target image displaying one or more new impact points each time the user fires projectiles from shooting device 112.

The IP algorithm residing on the computer processing server 108 further analyzes the impact points, including for example, the accuracy and/or point value established of each impact, the number of projectiles fired, time between shots, and other performance metrics. The computer processing server 108 processes, computes, and transmits the processed data as scores and/or proficiency metrics to be displayed on the touch screen device 104, thereby allowing the user to review his/her performance metrics, game scores, and/or proficiency progress among any other usable and trackable data within the art. The user may then continue with another round of the selected game until the current game has finished. Then the user(s) may select to replay the game, select a new game, review their proficiency metric results, share their performance metric(s) by emailing them and then uploading to the internet, social media, and the like, or exit the Live Fire Gaming system 100.

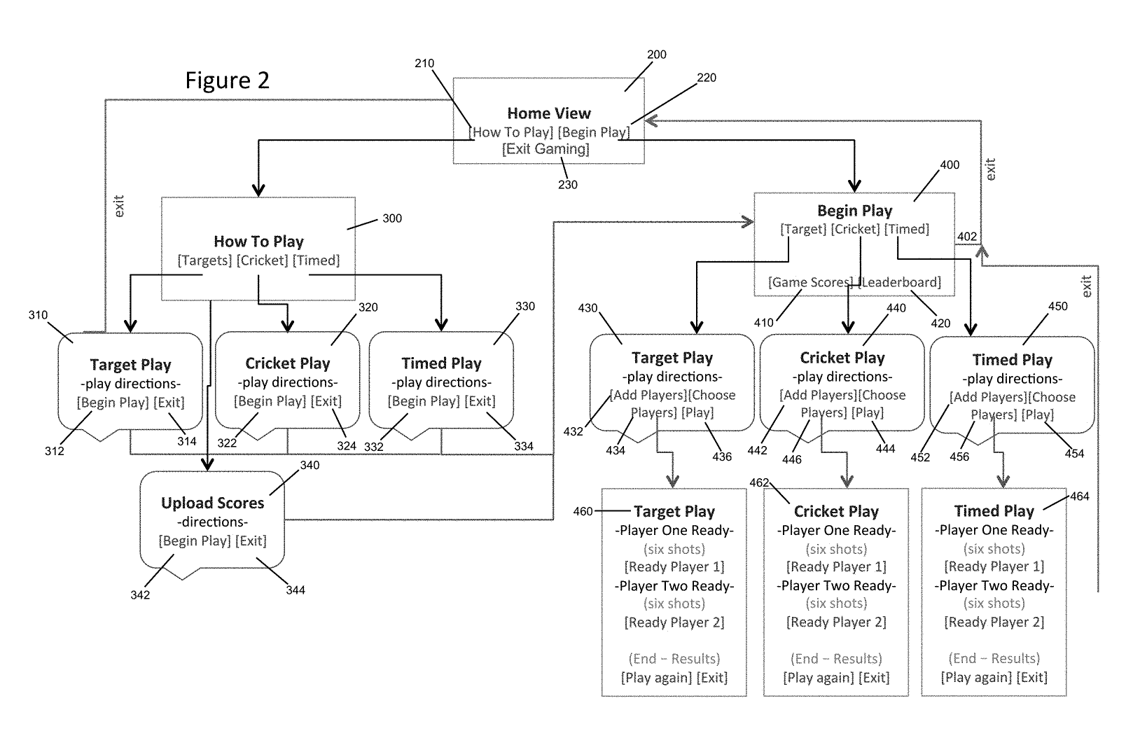

With reference now to FIGS. 2 through 14A, a user-interface flow diagram outlining the Live Fire Gaming system 100, as well as corresponding exemplary user-interface screens as they may generally appear on touch screen device 104, will now be described. While user-interface screens shown and described in FIGS. 2 thru 14A refer to specific games and examples (including “Target Play,” “Cricket Play,” and/or “Timed Play” gaming), it is to be understood that these games are shown by way of example, and the present disclosure is not limited to any specific games or gaming embodiments.

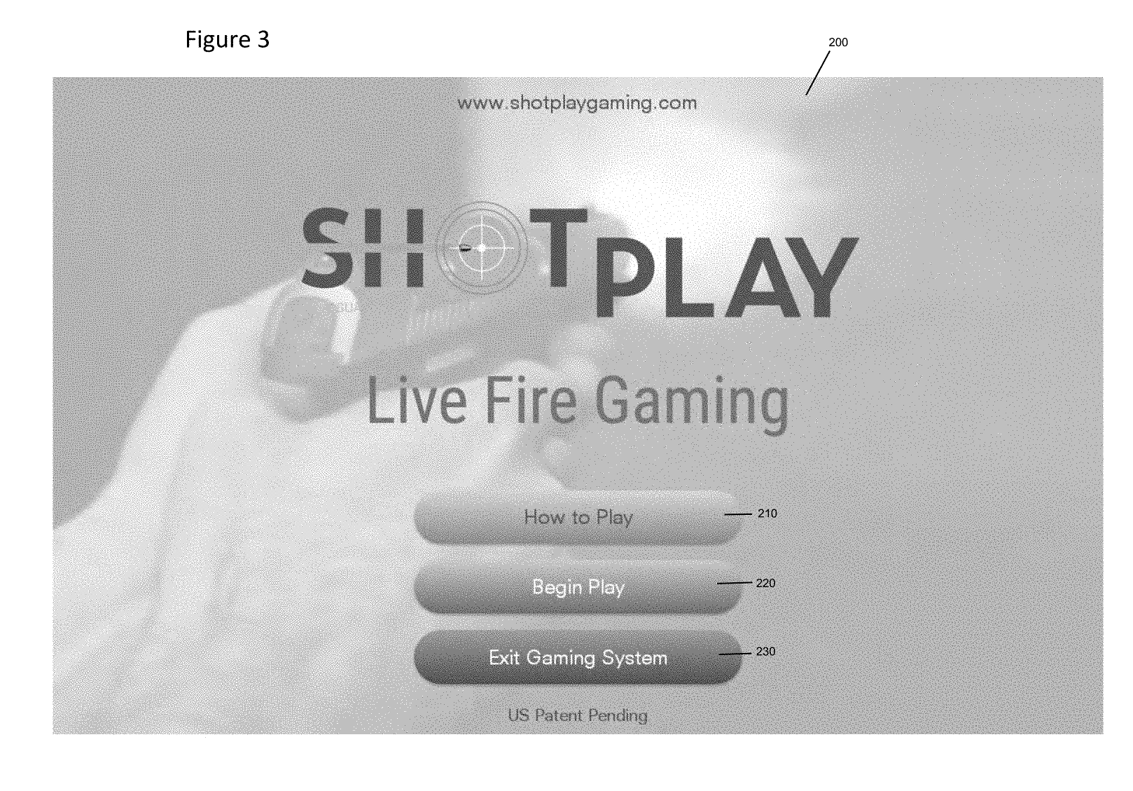

FIG. 2 depicts a generalized user-interface flow diagram depicting the method of the Live Fire Gaming system according to a preferred embodiment of the present disclosure. In FIG. 2, the user-interface flow diagram begins with a “Home View” 200, which allows a user to select between three options: “How To Play” 210, “Begin Play” 220, or “Exit Gaming System” 230. FIG. 3 depicts a corresponding exemplary user-interface screen for “Home View” 200.

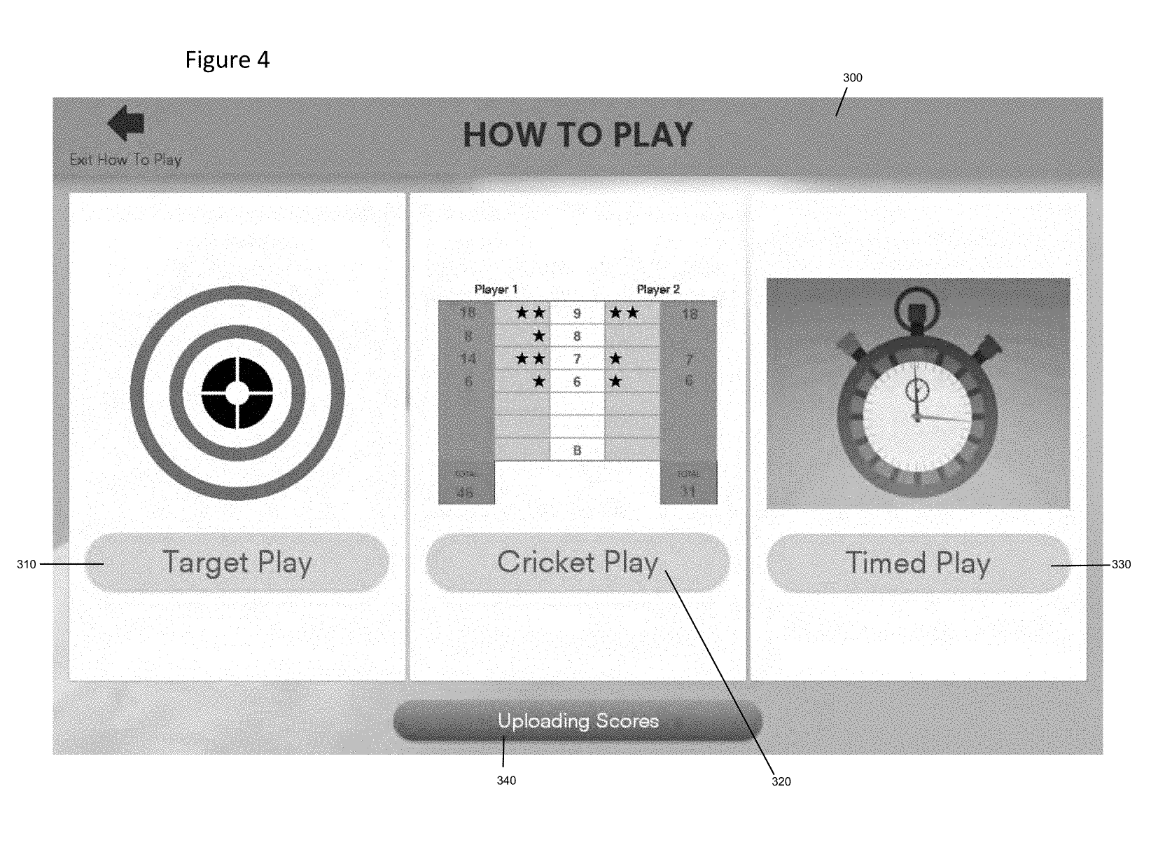

When a user selects “How to Play” 210 on “Home View” 200, as shown in FIG. 3, he/she may be directed to an exemplary user-interface “How to Play” screen 300, such as that depicted in FIG. 4. The user may then select and receive instruction on any one among a number of shooting games displayed on the “How To Play” screen 300. These may include, by way of example, instructions for “Target Play” 310, “Cricket Play” 320, and/or “Timed Play” 330. The user may also select “Uploading Scores” 340 to receive instructions for emailing performance metrics (including, by way of example, scores, results, and/or proficiency data), which may also be uploaded to social media, the internet, or the like.

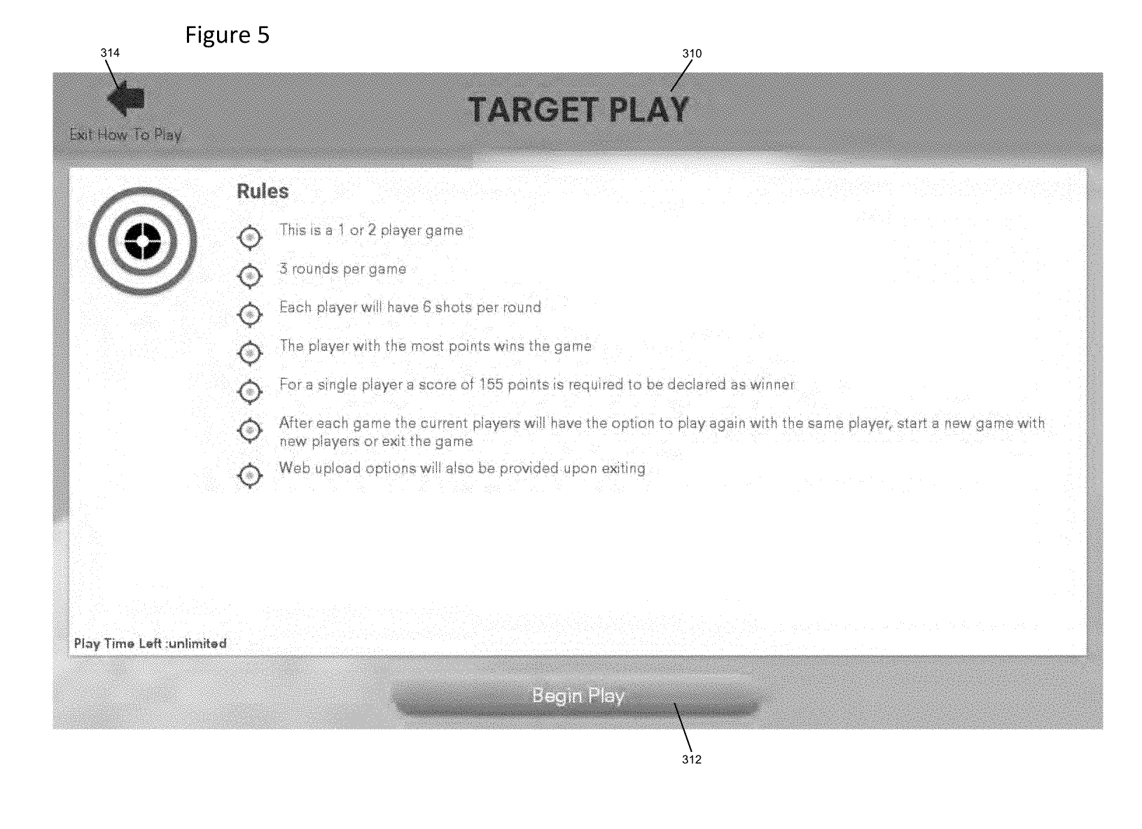

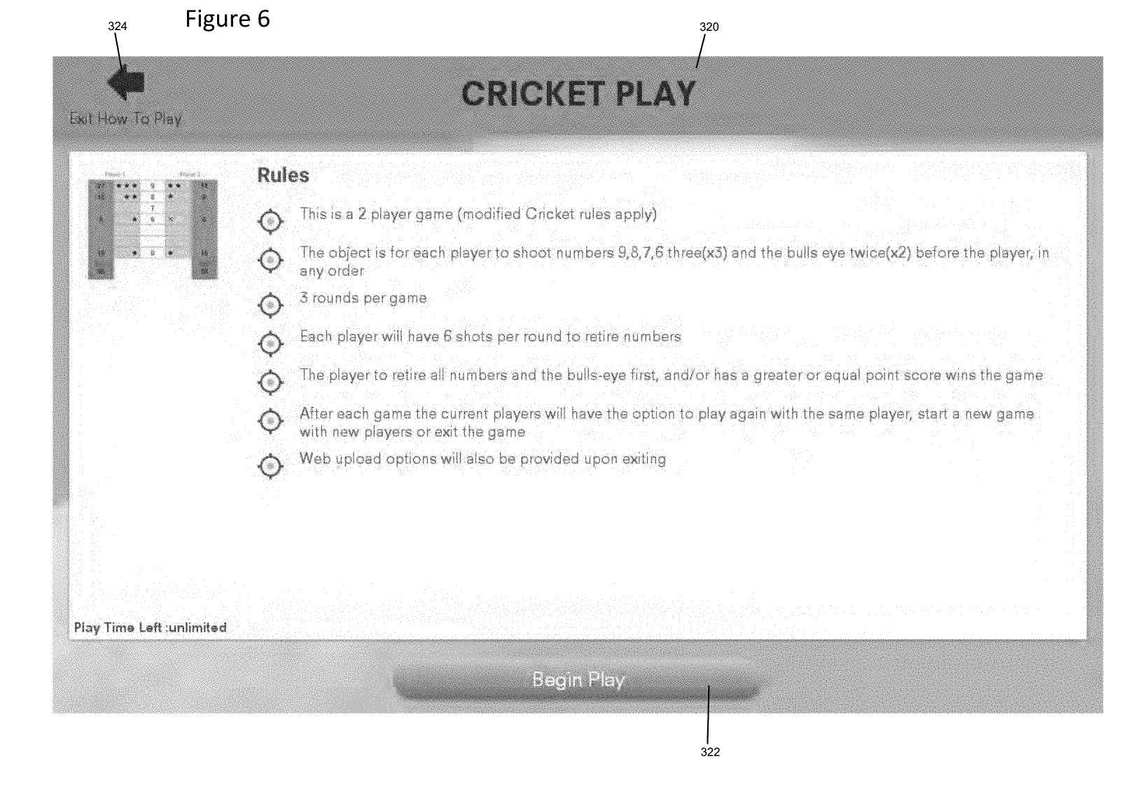

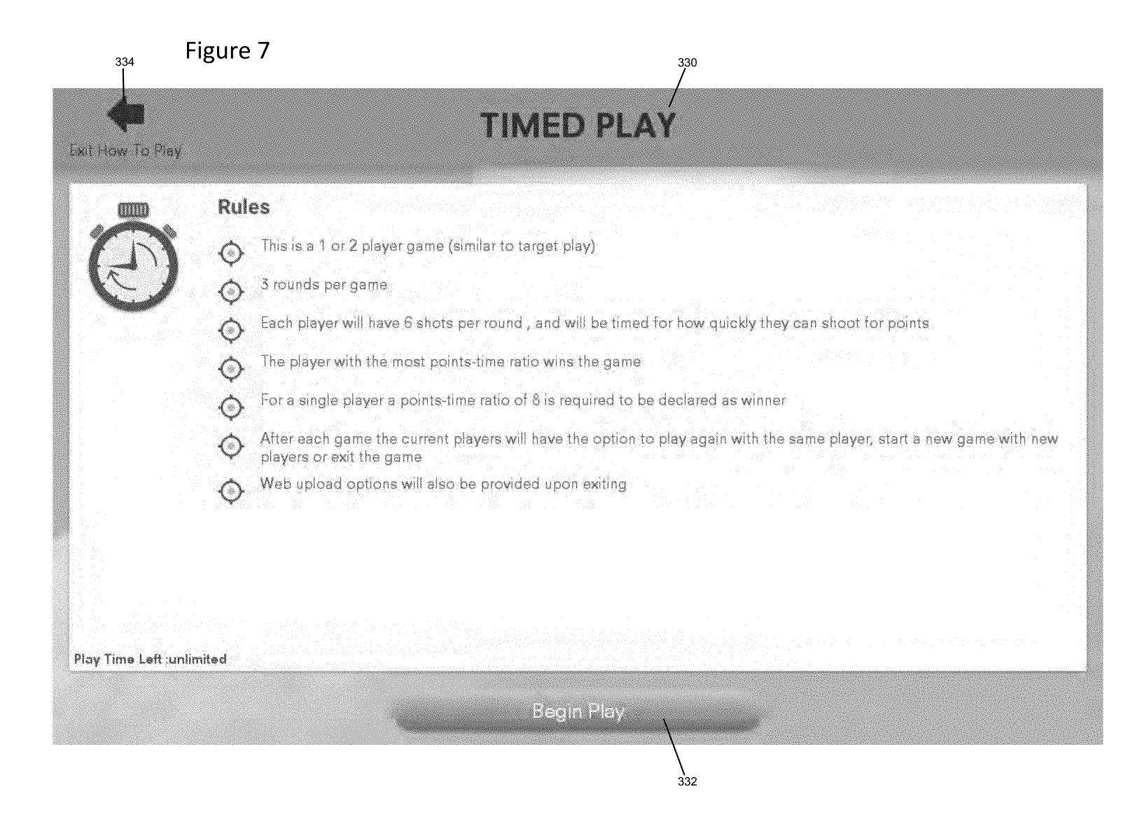

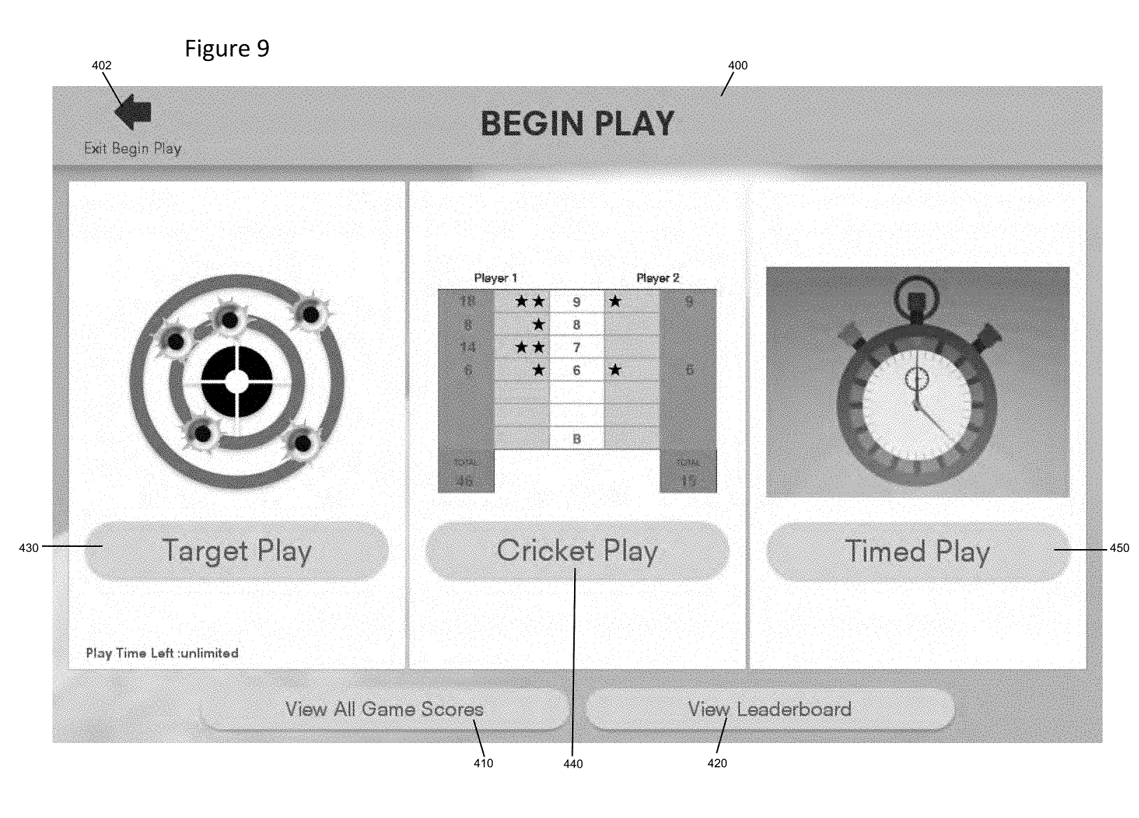

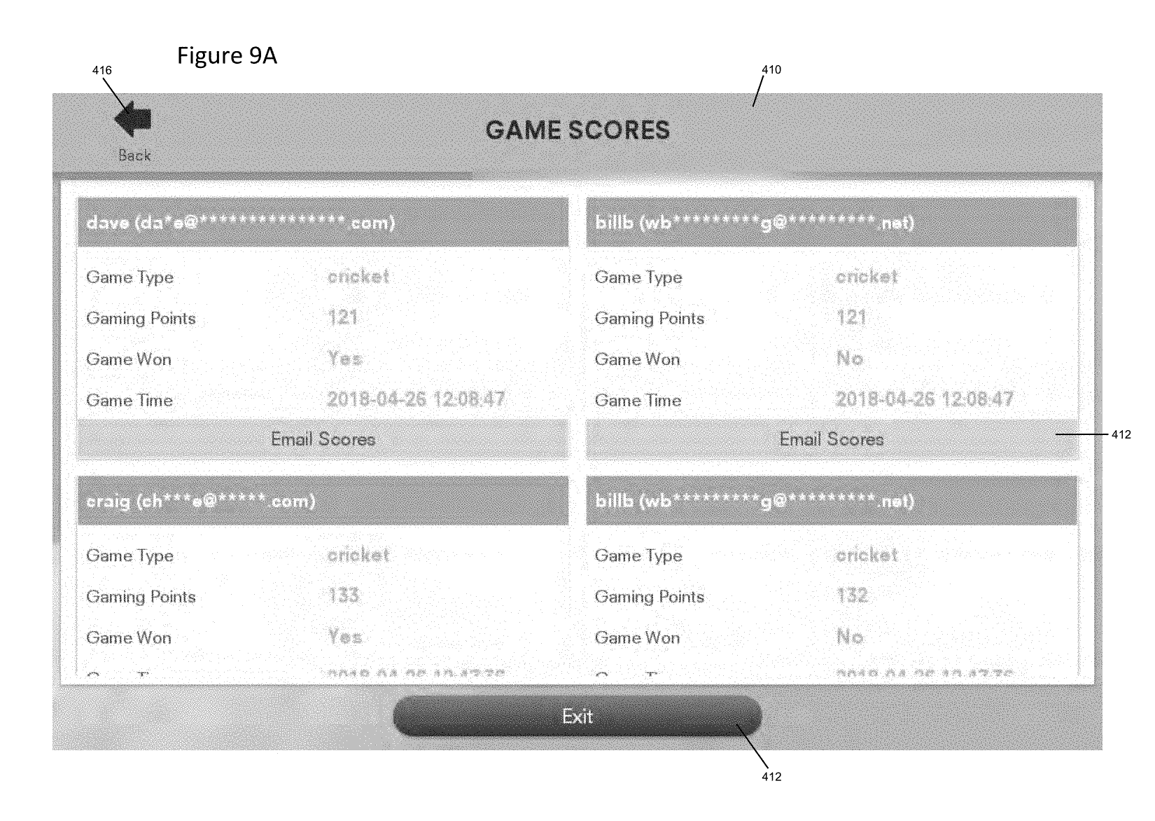

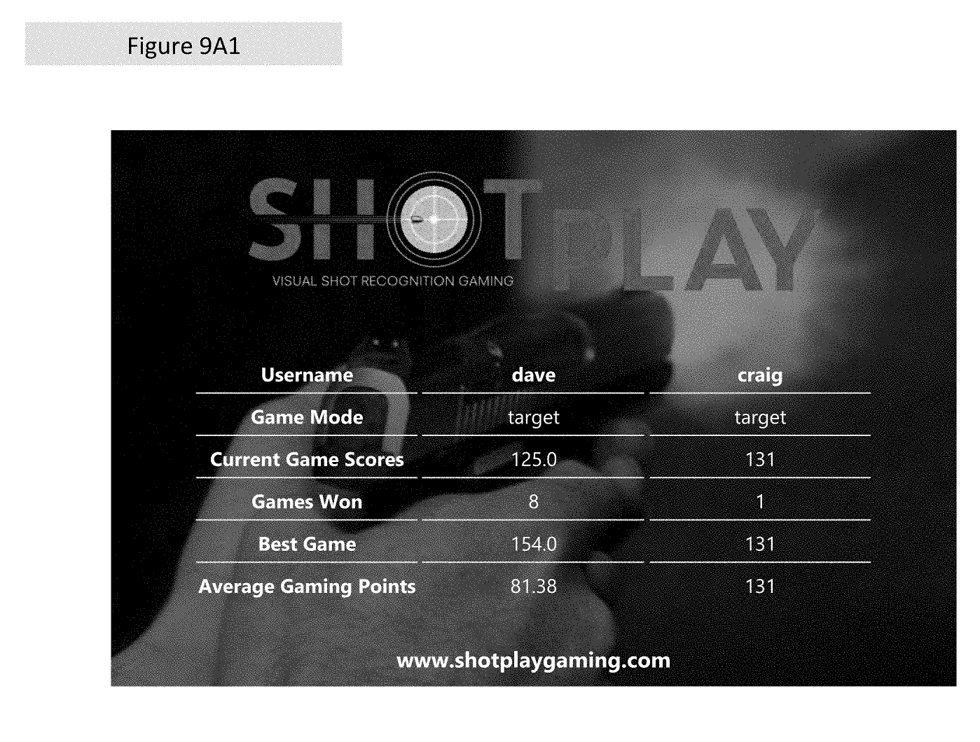

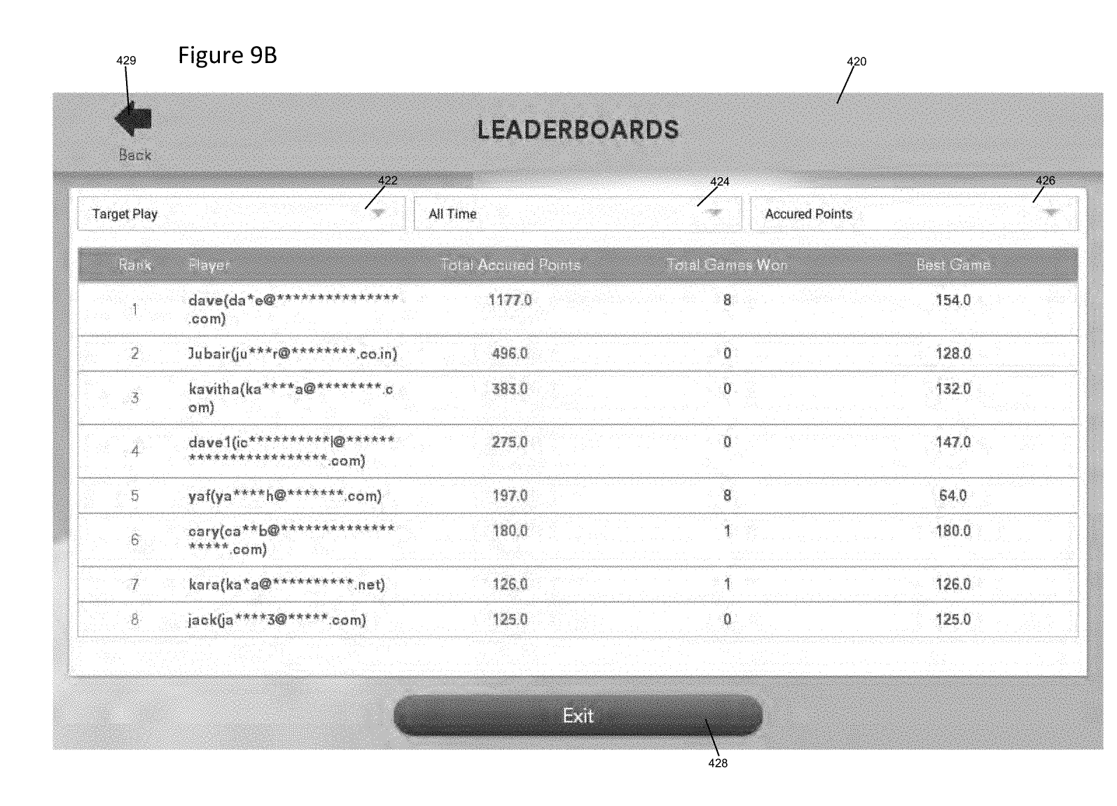

Reference is now made to FIGS. 5 through 7, wherein is depicted exemplary user-interface screens comprising user instructions and/or objectives for the exemplary shooting games available for user selection, as depicted in FIG. 4. FIG. 5 depicts an exemplary user-interface screen with user instructions for “Target Play” 310. This instructional user-interface screen may further include an “Exit How To Play” selection 314, which may allow the user to return to a previous screen, and a “Begin Play” selection 312 which may direct the user to a “Begin Play” screen 400 (see FIG. 9) to allow the user to commence playing a selected game. FIG. 6 depicts an exemplary user-interface screen with user instructions for “Cricket Play” 320. This instructional user-interface screen may further include an “Exit How To Play” selection 324, which may allow the user to return to a previous screen, and a “Begin Play” selection 322 which may direct the user to a “Begin Play” screen 400 (see FIG. 9) to allow the user to commence playing a selected game. FIG. 7 depicts an exemplary user-interface screen with user instructions for “Timed Play” 330. This instructional user-interface screen may further include an “Exit How To Play” selection 334, which may allow the user to return to a previous screen, and a “Begin Play” selection 332 which may direct the user to a “Begin Play” screen 400 (see FIG. 9) to allow the user to commence playing a selected game.

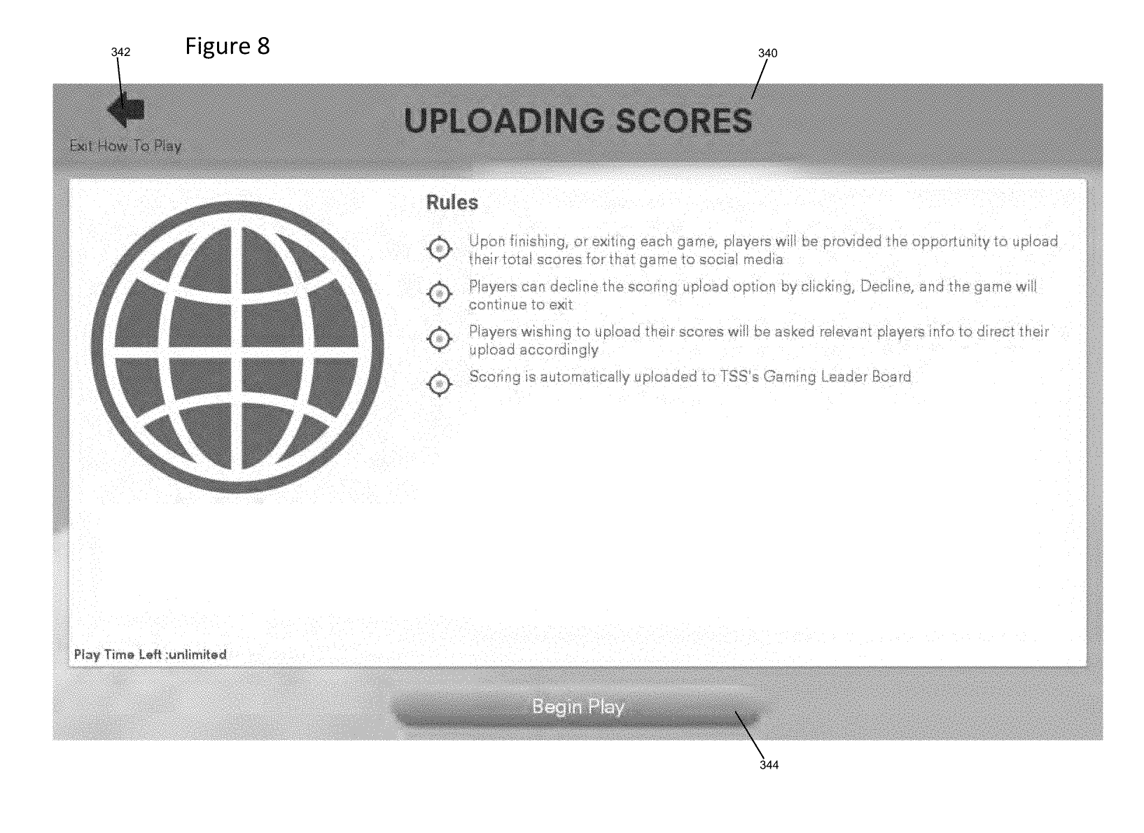

Reference is now made to FIG. 8, wherein is depicted an exemplary user-interface screen comprising user instructions for “Uploading Scores” 340. This instructional user-interface screen may provide instructions to the user regarding e-mailing performance metrics (such as scores, results, and/or proficiency data), which may be uploaded onto various internet websites, including social media sites, and/or onto an external application. The “Uploading Scores” 340 user-interface screen may further include an “Exit How To Play” selection 342, which may allow the user to return to a previous screen, and a “Begin Play” selection 344 which may direct the user to a “Begin Play” screen 400 (see FIG. 9) to allow the user to commence playing a selected game.

With reference now to FIG. 2 in conjunction with FIG. 9, the “Begin Play” selections 220, 312, 322, 332, 342 of FIG. 2 may direct the user to a “Begin Play” user-interface screen 400, which allows the user to select system games to play and receive play instructions relating thereto. These game selections may include, by way of example only and not limitation, “Target Play” 460, “Cricket Play” 462, and/or “Timed Play” 464, or any other game offered by the Live Fire Gaming system. As shown in FIG. 9, the “Begin Play” user-interface screen 400 may also allow a user to “View All Game Scores” 410 for the current gaming session, or “View Leaderboard” 420 which allows viewing of all retained scores for those users within provided time frames. The “Begin Play” user-interface screen 400 may also optionally allow the user to select any pre-designated target types (such as target 110 depicted in FIG. 1). This would allow the user the ability to randomly generate proficiency areas on a designated target surface (typically paper) thereby creating a target 110. The user may then select a game and receive play instructions of the game to be played (e.g., play instructions for “Target Play” 430, “Cricket Play” 440, “Timed Play” 450, or play instructions for any other game offered by the Live Fire Gaming system 100 or devised in the art). The “Begin Play” user-interface screen 400 may also include an “Exit Begin Play” selection 402 to enable a user to return to the previous “Home View” 200.

With reference now to FIG. 2 in conjunction with FIGS. 9, 9A and 9A1, when the user selects the “View All Game Scores” 410 of FIG. 9, the “Game Scores” user-interface screen 410, as shown by way of example in FIG. 9A, may allow users to view all game scores for a current gaming session, including but not limited to games played in “Target Play” 460, “Cricket Play” 462, and/or “Timed Play” 464, or any other game offered by the Live Fire Gaming System or devised in the art. As shown in FIG. 9A, the “Game Scores” user-interface screen 410 may also allow a user, by selecting “Email Scores” 412, to email performance metrics, such as current game scores, results, and/or proficiency data, to themselves and thereby upload such performance metrics onto various internet websites, such as social media sites, and/or onto an external application, etc. FIG. 9A1 depicts an exemplary graphic with performance metrics that may be emailed by a user and uploaded onto internet websites or social media sites. With continued reference to FIG. 9A, the “Game Score” user-interface screen 410 may also include an “Exit”412 or “Back” 416 selection to enable a user to return to the previous “Begin Play” user-interface screen 400 of FIG. 9.

With reference now to FIG. 2 in conjunction with FIGS. 9 and 9B, when the user selects the “View Leaderboard” 420 of FIG. 9, the “Leaderboards” user-interface screen 420, as shown by way of example in FIG. 9B, may allow users to view game scores and/or performance metrics for current and past gaming sessions for applicable users within specified time frames, including but not limited to those games played in “Target Play” 460, “Cricket Play” 462, and/or “Timed Play” 464, or any other game offered by the Live Fire Gaming system or devised in the art. As shown in FIG. 9B, the “Leaderboards” user-interface screen 420 may allow a user, through drop-down menus 422, 424, 426, the ability to filter all applicable user score results or metrics for each game. The “Leaderboards” user-interface screen 420 may also include an “Exit” 428 or “Back” 429 selection to enable a user to return to the previous “Begin Play” user-interface screen 400 of FIG. 9.

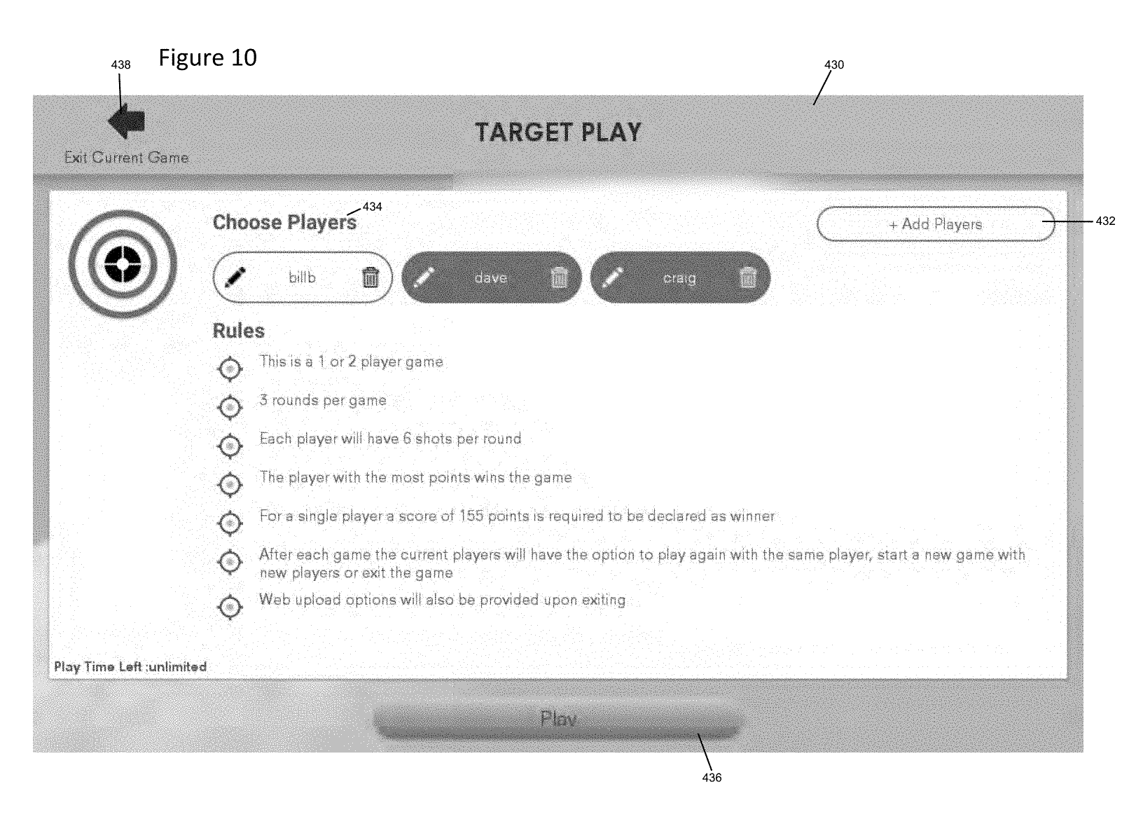

With reference now to FIGS. 10 through 12, user-interface screens with play instructions for one exemplary game, “Target Play” 430, of the Live Fire Gaming system referenced in FIG. 9 is depicted. In FIG. 10, the user (after having selected “Target Play” 430 on the “Begin Play” user-interface screen 400 in FIG. 9) may add any number of desired players by selecting “Add Players” 432. From the list of added players, the user may then select the name(s) of the player(s) who will play the game by selecting “Choose Players” 434. Once all players for the current game (“Target Play”) have been selected, the user may then select “Play” 436 to begin playing the game. The user-interface screen for playing directions for “Target Play” 430 may also allow a user to edit or delete information relating to the added players (e.g., player name, email address, etc.), and may include basic instructions and/or objectives of the game.

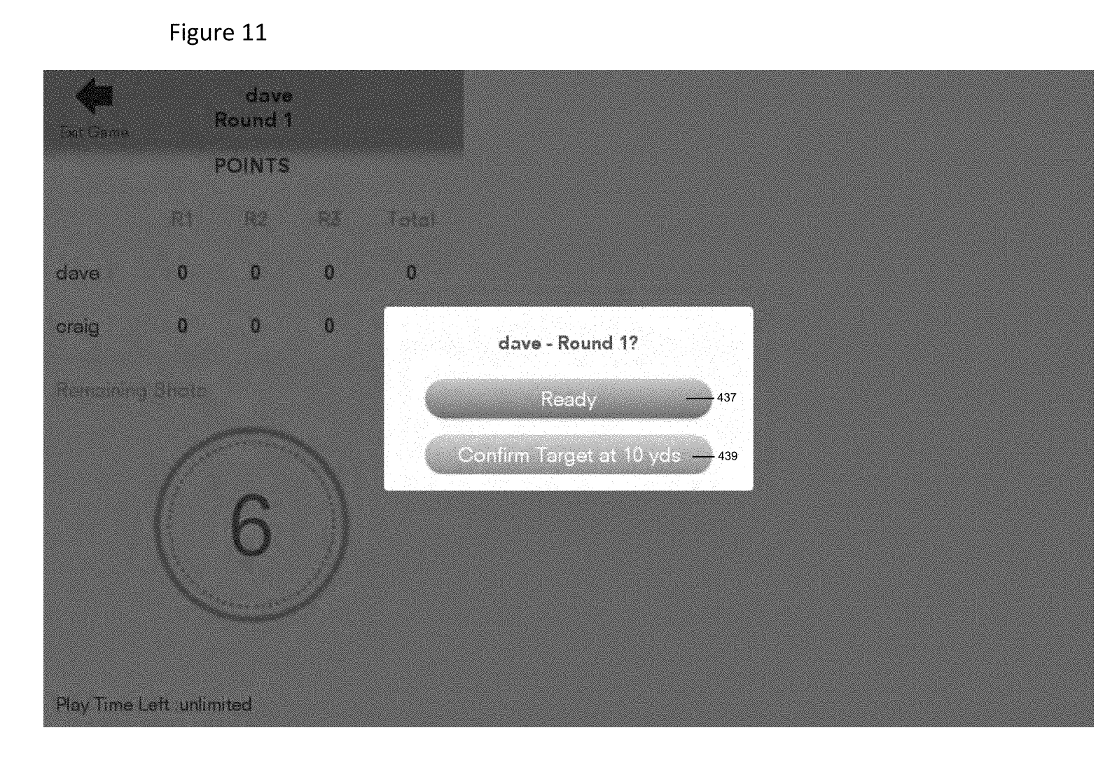

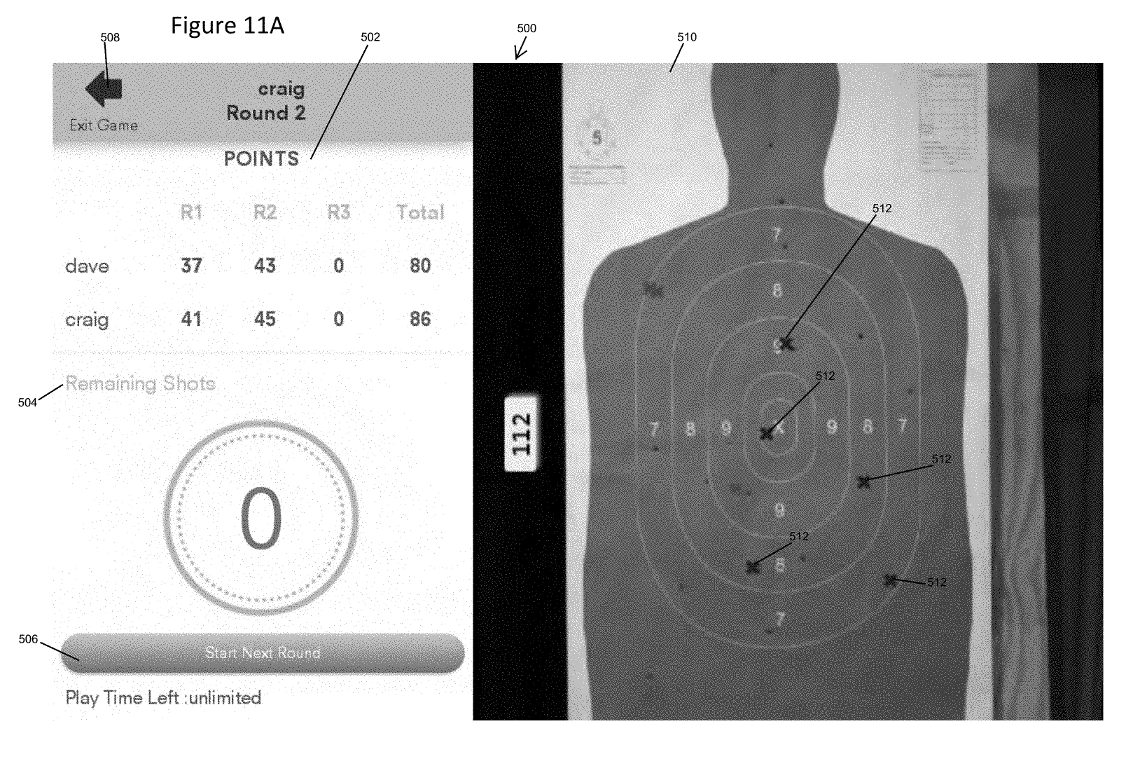

With reference to FIG. 11, once the user selects “Play” 436 in FIG. 10, each user may begin game play for each round by “Confirming Target at 10 yds” 439 for the target 110. This action may initiate camera 102 capabilities so that images may be captured to show impact points for each projectile fired by the shooting device upon the target 110 for each player in a game. Selection of “Ready” 437 may prompt camera 102 to begin relaying images of target 110 to the computer processing server 108. The user may then commence shooting at the target 110.

FIG. 11A depicts touch screen device 104 showing a split screen user interface screen 500 once gaming for “Target Play” has commenced. Touch screen device 104 may show, e.g., performance metrics of the player(s), including point progress 502, remaining shots available for each player 504, as well as a live-camera visual 510 of the target 110. After a designated number of shots (e.g., 6 shots per round) by the user have been recognized by the IP software algorithm of computer processing server 108 (based on images captured, collected, and relayed by the camera 102 to computer processing server 108), the user's shot proficiency may be processed by the computer processing server 108 and then displayed on the touch screen device 104. Higher point values may be assigned to correspondingly higher-value areas of the target 110 as may be designated. Play for that round may then end for the first user and begin for a second user (if applicable). Second user may begin by selecting the “Confirming Target 10 yds” 439 and thereafter “Ready” 437 options (see FIG. 11), and the process of play may mirror the process previously described for the first user. A designated number of rounds (e.g., 3 rounds per game) may be played to complete a game cycle. The user with the most points after, for example, 3 rounds of play (6 shots per round), wins the game played. Additionally, for each round of play with more than one player, each player's impact points 512 on the target 110 may have distinguished colored markers identifying such (e.g., red “x” marker for the first player, and blue “x” markers for the second player, etc., where the most recent shot may be initially shown with a green “x” marker which then turns into the red or blue colored marker based on the player completing the shot). Alternatively, a user may choose to play alone, and scoring may be compared to a designated point value (e.g., 155 points, or the daily top 70 percentile game play points for that game), and the player's identified impact points on the target 110 may be the same marker color. As further shown in FIG. 11A, once a round of gaming has ended, users may also select “Start Next Round” 506 to start another round of play or “Exit Game” 508 to exit the game.

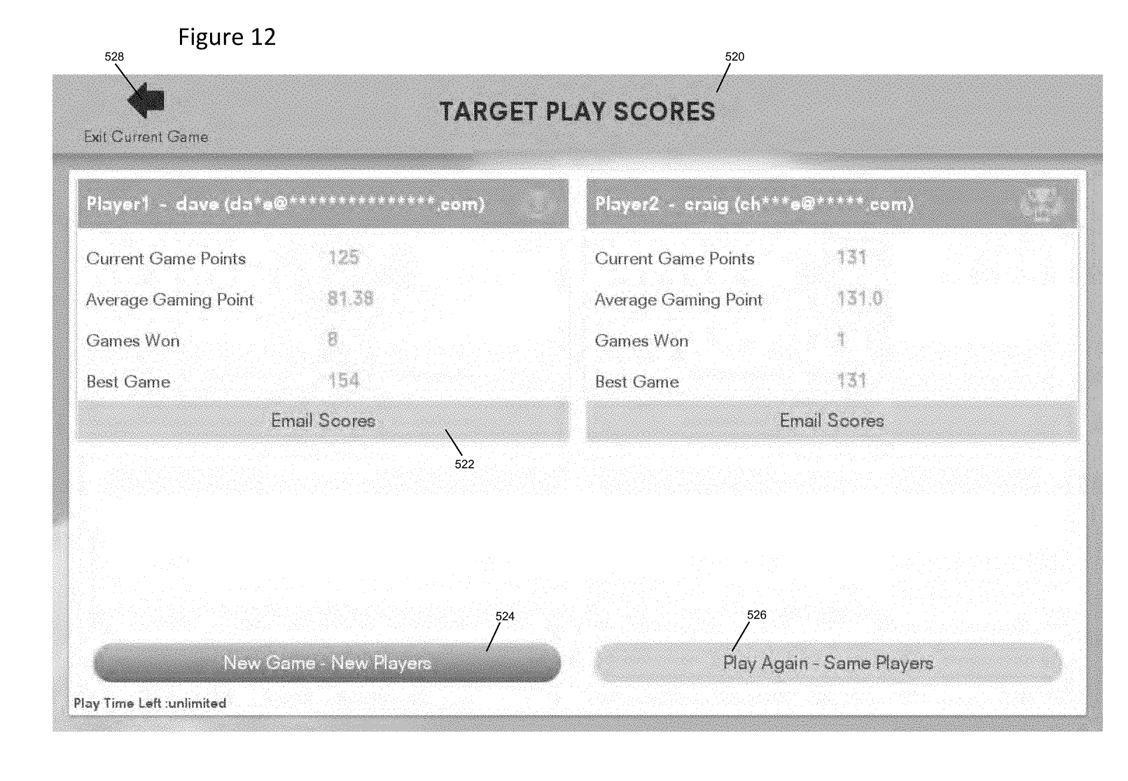

With reference now to FIG. 12, “Target Play Scores” user-interface screen 520 may be depicted on touch screen device 104 to show, for each individual game at this stage of game play, shot performance metrics and/or proficiency for player(s) of that completed game. Performance and/or proficiency metrics may include, but are not limited to, current game points, games won, points accumulated, best scores, etc. for the identified game. As shown in FIG. 12, the “Target Play Scores” user-interface screen 520, the user may email the performance metrics (including the current game scores, results, and/or proficiency data) to themselves by selecting “Email Scores” 522, and thereby upload the information onto various internet websites, such as social media sites, and/or onto an external application, etc. The user may then decide to play a new game with the same players by selecting “Play Again-Same Players” 526, play a new game with new players by selecting “New Game-New Players” 524, or exit the current game by selecting “Exit Current Game” 528. If the user opts to exit the current game, the user may return to the “Begin Play” user-interface screen 400 (FIG. 9) with the option to play a different game or permanently exit from the Live Fire Gaming system 100.

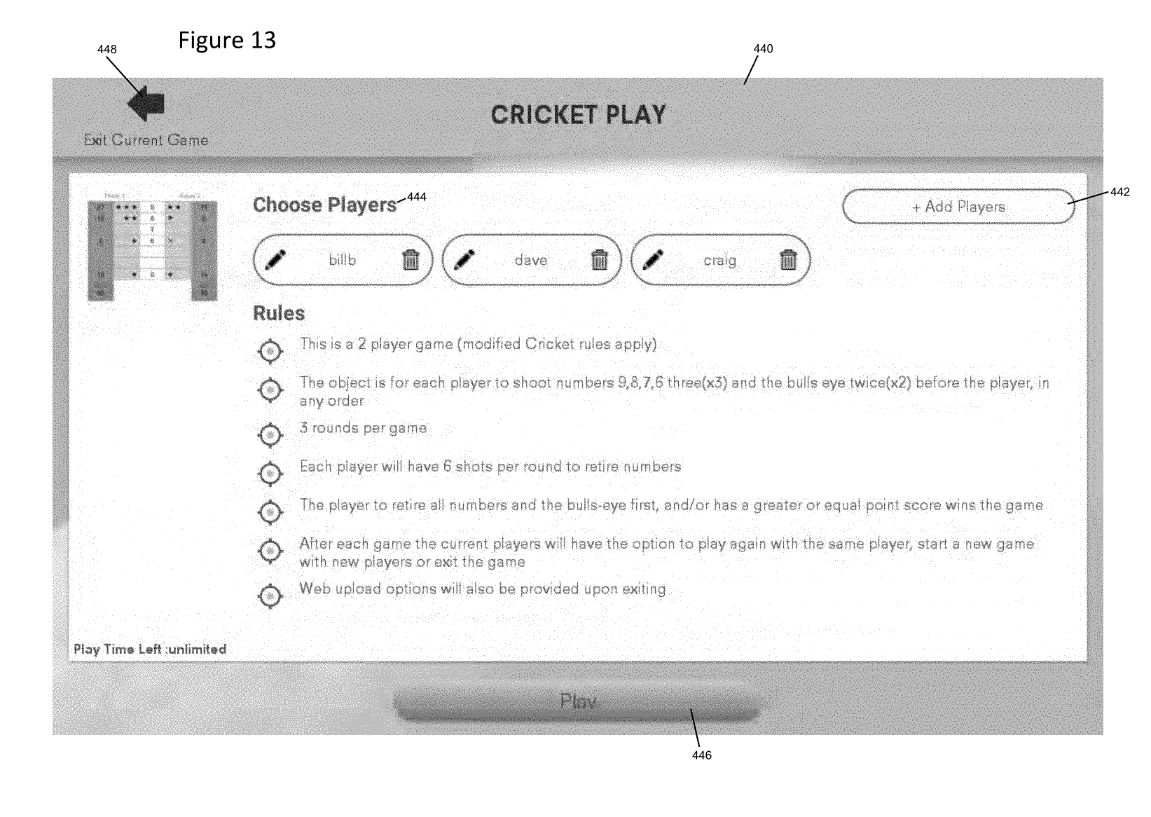

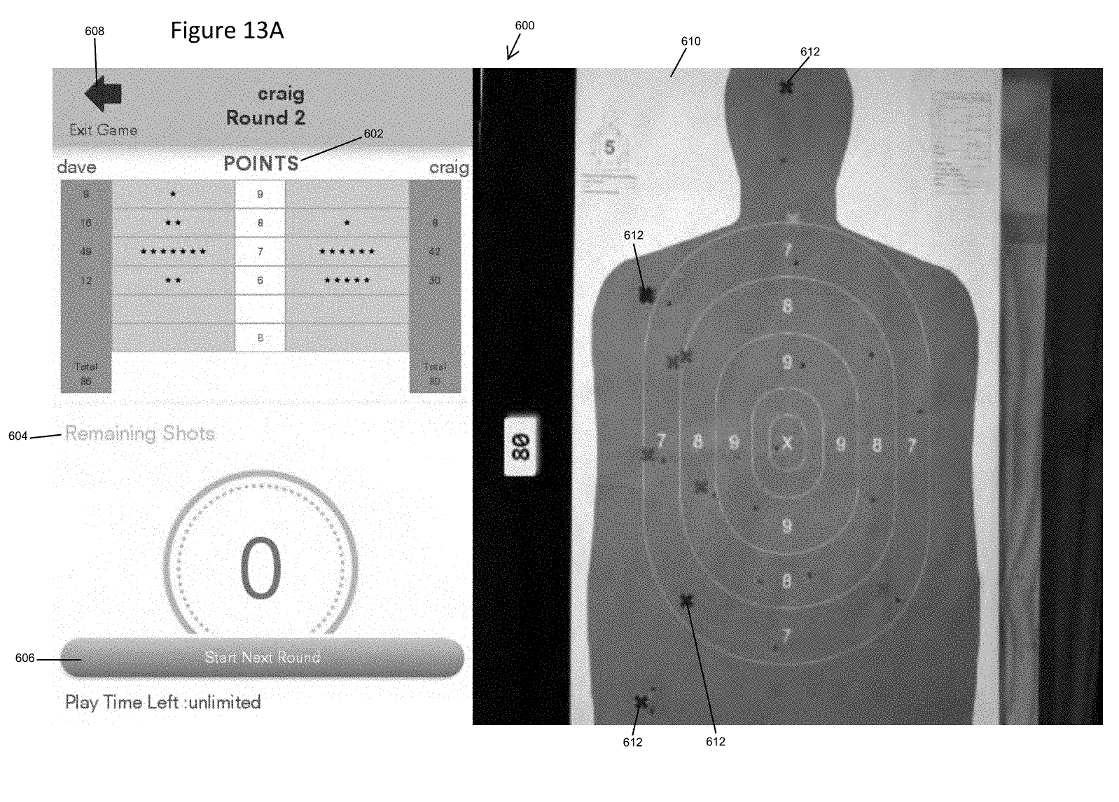

Reference is now made to FIGS. 13 and 13A, wherein is depicted another exemplary game, “Cricket Play” 440. As in “Target Play” 430 of FIG. 10, “Cricket Play” 440 may allow a user to add any number of desired players by selecting “Add Players” 442. From the list of added players, the user may then select the name(s) of the player(s) who will play the game by selecting “Choose Players” 444. Once all players for the current game (“Cricket Play”) have been selected, the user may then select “Play” 446 to begin playing the game. The user-interface screen for “Cricket Play” 430 may also allow a user to edit or delete information relating to the added players (e.g., player name, email address, etc.), and may include basic instructions and/or objectives of the game. The game may initiate in the same manner, including by initiating capabilities of camera 102, as described above in conjunction with “Target Play” of FIGS. 10-11. For example, once the user selects “Play” 446 shown in FIG. 13, each user may begin game play for each round by “Confirming Target at 10 yds” for the target 110. This action may initiate camera 102 capabilities so that images may be captured to show impact points for each projectile fired by the shooting device upon the target for each player in a game. Selection of “Ready” may prompt camera 102 to begin relaying images of target 110 to the computer processing server 108. The user may then commence shooting at the target 110, and aiming to hit each of the displayed numerals and/or bulls-eye, as may be required by rules of the game.

With reference to FIG. 13A, once the user selects “Play” 446 (as shown in FIG. 13), touch screen device 104 may depict a split screen user-interface screen 600 showing performance metrics, e.g., proficiency data relating to the player(s), point progress 602, shots available for each player 604, as well as a live-camera visual of the target 110. After a designated number of shots (e.g., 6 shots per round) by the user have been recognized by the IP software algorithm of computer processing server 108 (based on images captured, collected, and relayed by the camera 102 to computer processing server 108), the round for the user may cease and the user's shot proficiency may be processed by the computer processing server 108 and then displayed on the touch screen device 104. Point progress may be shown after a predetermined number of shots are fired in a round and recognized by the computer processing server 108. Play may then end for the first user and commence for a second user. Second user may begin by selecting a “Confirming Target 10 yds” and/or “Ready” options (as discussed in conjunction with “Target Play” in FIG. 11), and the process of play may mirror the process previously described for the first user. The game generally is won by shooting each numerical and/or bulls-eye a pre-determined number of times (thereby retiring the target). A designated number of rounds may be played to complete a game cycle, or a game may be completed when a first user “retires the target”, as required by rules of the game. The user to “retire the target” first, and/or accumulates the most points or equal points after three rounds of play may win the game. Additionally, for each round of play, and as “Cricket Play” requires two players, each player's impact points 612 on the target 110 may have distinguished colored markers identifying such (e.g. red “x” marker for the first player, and blue “x” markers for the second player, etc., where the most recent identified shot may be initially shown with a green “x” marker which then turns into a red or blue colored marker based on the player that completed the shot). As further shown in FIG. 13A, once a round of gaming has ended, users may select “Start Next Round” 606 to start another round of play, or “Exit Game” 608 to exit the game.

As described above in conjunction with FIG. 12 (“Target Play Scores”), after completing a “Cricket Play” game (and for each individual game at this stage of game play), performance metrics and/or proficiency data for player(s) of the completed game may be displayed on the touch screen device 104. Performance metrics may include, but are not limited to, current game points, games won, points accumulated, best scores, etc. for the game. The user may then decide to play a new game with the same players or with new players, or alternatively, to exit the current game. As further described in conjunction with FIG. 12 (“Target Play Scores”), a user completing or participating in “Cricket Play” may also email his/her performance metrics, including the current game score, results, and/or proficiency data to themselves and thereby upload the data onto various internet websites, such as social media sites, and/or onto an external application, etc. If the user opts to exit the current game, the user may return to the “Begin Play” user-interface screen 400 (FIG. 9) with the option to play a different game or permanently exit from the Live Fire Gaming system 100.

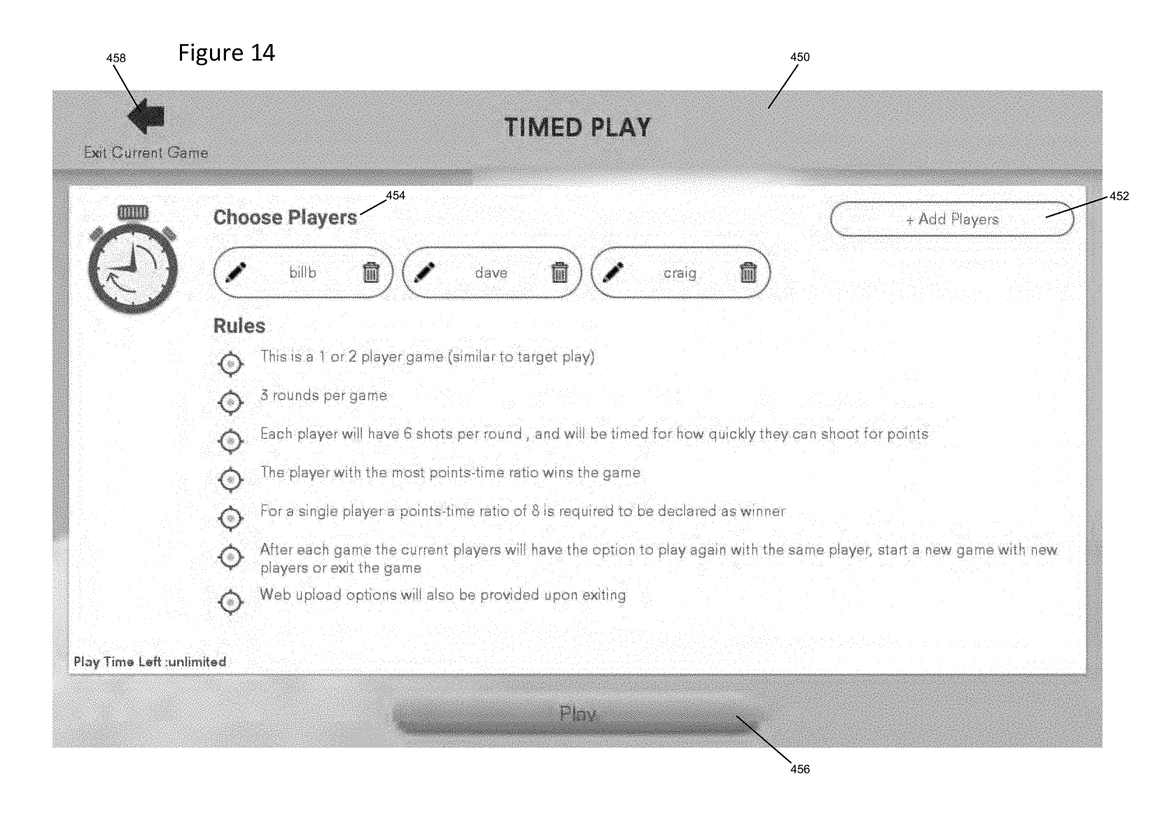

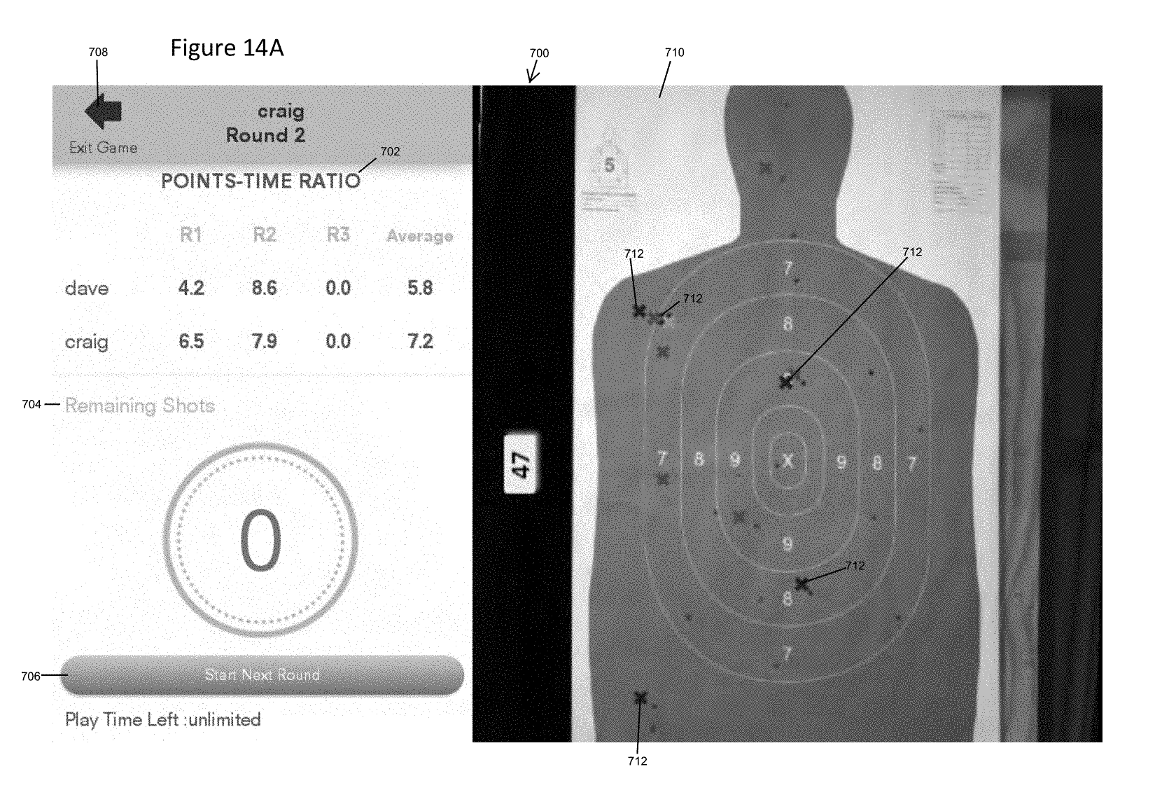

Reference is now made to FIG. 14, wherein is depicted an exemplary game, “Timed Play” 450. As in “Target Play” 430 and “Cricket Play” 440, “Timed Play” 450 may allow a user may add any number of desired players by selecting “Add Players” 452. From the list of added players, the user may then select the name(s) of the player(s) who will play the game by selecting “Choose Players” 454. Once all players for the current game (“Timed Play”) have been selected, the user may then select “Play” 456 to begin playing the game. The user-interface screen for “Timed Play” 430 may also allow a user to edit or delete information relating to the added players (e.g., player name, email address, etc.), and may include basic instructions and/or objectives of the game. The game may initiate in the same manner, including by initiating capabilities of camera 102, as described above in conjunction with “Target Play” of FIGS. 10-11. For example, once the user selects “Play” 456 shown in FIG. 14, each user may begin game play for each round by “Confirming Target at 10 yds” for the target 110. This action may initiate camera 102 capabilities so that images may be captured to show impact points for each projectile fired by the shooting device upon the target for each player in a game. Selection of “Ready” may prompt camera 102 to begin relaying images of target 110 to the computer processing server 108. The user may then commence shooting at the target 110, as may be required by rules of the game.

With reference to FIG. 14A, once the user selects “Play” 456 (as shown in FIG. 14), touch screen device 104 may depict a split screen user-interface screen 700 showing performance metrics, e.g., proficiency data relating to the players(s), points/time ratios 702 for each player, shots available for each player 704, as well as a live-camera visual 710 of the target 110. After a designated number of shots (e.g., 6 shots per round) by the user have been recognized by the IP software algorithm of the computer processing servers 108, the time clock may stop, the user's turn may cease, and the user's shot proficiency may be processed by the computer processing server 108, and then displayed on the touch screen device 104. Higher point values may be assigned to correspondingly higher-value areas of the target 110 as may be designated. Play may then end for the first user and begin for a second user (if applicable). Second user may begin by selecting the “Ready” option, and the process of play may mirror the process previously for the first user. A designated number of rounds may be played to complete a game cycle. In “Timed Play,” the user with the highest point/time ratio value after 3 rounds of play, establishing a combined proficiency in accuracy and speed, wins the game played. Additionally, for each round of play with more than one player, each player's impact points 712 on the target 110 may have distinguished colored markers identifying such (e.g., red “x” marker for the first player, and blue “x” markers for the second player, etc., where the most recently-fired shot may be initially shown with a green “x” marker which then turns into a red or blue colored marker corresponding to the player that completed the shot). Alternatively, if a user chooses to play alone, scoring may be compared to a designated point value (e.g., 8 Points-Time Ratio, or the daily top 70 percentile Points-Time Ratio for that game), and the player's identified impact points on the target 110 may be a single marker color.

As described above in conjunction with FIG. 12 (“Target Play Scores”), after completing a “Timed Play” game, shot performance metrics and/or proficiency data may include for players may be displayed on the touch screen device 104. Performance metrics and/or proficiency data may include, but are not limited to, current game points, games won, points accumulated, points/time ratios, best scores, etc. for the game. The user may then decide to play a new game with the same players or with new players, or alternatively, to exit the current game. As further described in conjunction with FIG. 12 (“Target Play Scores”), the user playing “Timed Play” may email the performance metrics (including the current game scores, results, and/or proficiency data) to themselves and thereby upload onto various internet websites, such as social media sites, and/or onto an external application, etc. If the user opts to exit the current game, the user may return to the “Begin Play” user-interface screen 400 (FIG. 9) with the option to play a different game or permanently exit from the Live Fire Gaming system 100.

It is to be understood that the implementations are not limited to particular systems or methods described, which may, of course, vary. For example, the Live Fire Gaming system 100 need not be limited to the specific methods, system components, and/or user interface displays disclosed herein. Likewise, the Live Fire Gaming system 100 is not limited to the specific games and/or the methods of playing disclosed herein. There may be other variations, iterations, and designs for the Live Fire Gaming system 100 and/or games that allow for calculation of similar performance metrics and/or scores in single and/or multi-player gaming mode (in person or on-line). Additionally, the Live Fire Gaming system 100 and methods described herein may be adapted for use with various technologies, environments, and applications, including web and/or mobile applications, virtual applications, etc. Moreover, the invention defined by the above paragraphs is not to be limited to particular details set forth in the above description, as many apparent variations thereof are possible without departing from the spirit or scope of the present disclosure. It is also to be understood that the terminology used herein is for the purposes of describing particular implementations only and is not intended to be limiting.

1. A system for live fire gaming comprising:
a shooting device for shooting projectiles onto a target;
a camera for capturing images relating to impact points of the projectiles on the target;
a processing means coupled to the camera for calculating a performance metric based on data from the images relating to the impact points of the projectiles on the target; and
a touch screen display coupled to the processing means for displaying the performance metric.

2. The system of claim 1, wherein the touch screen display further displays gaming information.

3. The system of claim 2, wherein the gaming information comprises:
instructions for gaming.

4. The system of claim 2, wherein the gaming information comprises:
options for gaming.

5. The system of claim 1, wherein the touch screen display further displays an enlarged view of the target.

6. The system of claim 1, wherein the touch screen display further displays images captured by the camera.

7. The system of claim 1, wherein the touch screen display further displays the impact points on the target.

8. The system of claim 1, wherein the processing means calculates the performance metric based on information transferred from the camera to the processing means relating to the impact points of the projectiles on the target.

9. The system of claim 1, wherein the performance metric comprises:
measurements relating to accuracy of the impact points.

10. The system of claim 9, wherein the performance metric further comprises:
point values based on the accuracy of the impact points.

11. The system of claim 1, wherein the performance metric comprises:
a number of projectiles shot.

12. The system of claim 1, wherein the performance metric comprises:
speed by which the projectiles are shot.

13. The system of claim 1, wherein the performance metric is capable of being uploaded to the internet.

14. The system of claim 1, wherein the performance metric is capable of being uploaded on linked social media sites.

15. The system of claim 1, wherein the gaming may comprise:
multiple players.

16. The system of claim 15, wherein the performance metric may comprise:
data relating to shots of the multiple players.

17. A method for live fire gaming comprising the steps of:
firing one or more projectiles from a shooting device onto a target;
capturing images relating to one or more impact points of the projectiles on the target;
calculating a performance metric based on data from the images relating to the one or more impact points of the projectiles on the target; and
displaying the performance metric on a touch screen device.

18. The method of claim 17 further comprising:
selecting a gaming option from among a plurality of gaming options.

19. The method of claim 17 further comprising:
displaying an enlarged view of the target on the touch screen device.

20. The method of claim 17 further comprising:
displaying the impact points of the projectiles on the touch screen device.

21. The method of claim 17 further comprising:
uploading the performance metric onto linked social media sites.

22. The method of claim 17 further comprising:
uploading the performance metric onto the internet.
